(19) United States
(12) Patent Application Publication
(10) Pub. No.: US 2009/0156044 A1
(43) Pub. Date: Jun. 18, 2009

(54) Electrical Connector and Contact Insertion Guide

(76) Inventors: Yusuke Mito, Tokyo (JP); Hidetaka Homme, Tokyo (JP)

Correspondence Address: BARLEY SNYDER, LLC, 1000 WESTLAKES DRIVE, SUITE 275, BERWYN, PA, 19312, US

(21) Appl. No.: 12/338,688

(22) Filed: Dec. 18, 2008

(30) Foreign Application Priority Data
Dec. 18, 2007 (JP) 2007-326148

(51) Int. Cl. H01R 4/50; H01R 13/60

(52) U.S. Cl. 439/343; 439/575

(57) ABSTRACT

The invention relates to a contact insertion guide structure having a contact and an insulative housing. The contact has a mating portion for contacting a mating contact at one end, a terminal portion for connecting to a circuit board on an opposite end, and a press-fit section between the mating portion and the terminal portion. The housing has a contact receiving passageway through which the contact is inserted, and a securing section which is formed in an inner wall of the contact receiving passageway and into which the press-fit section is received. The housing further includes a wide section that does not contact the contact and is formed in an inner wall of the contact receiving passageway proximate to the securing section. A contact support section is formed in the inner wall of the contact receiving passageway. The contact support section guides the contact while coming in contact with it at the time of insertion. The contact support section also supports a portion of the contact between the mating portion and the press-fit section.

### CROSS-REFERENCE TO RELATED APPLICATIONS

This is application claims the benefit of the filing date under 35 U.S.C. §119(a)-(d) of Japanese Patent Application No. 2007-326148, filed Dec. 18, 2007.

### FIELD OF THE INVENTION

The invention relates to a contact insertion guide structure and an electrical connector, and particularly relates to a contact insertion guide structure formed of terminals and an insulating housing, and an electrical connector using the contact insertion guide structure.

### BACKGROUND

Electrical connectors having a structure in which terminals are press-fit into an insulative housing, such as synthetic resin material, are readily known. Among such electrical connectors, some are mounted and soldered on a circuit board.

A V-type electrical connector mounted on a circuit board receives a mating connector perpendicular to the circuit board. In the V-type electrical connector, for example, terminals each have: a press-fit section secured in a through hole formed in a bottom wall of a concave section of the housing; a contact section that linearly extends in the housing from the press-fit section to contact a mating terminal; and a connection section that linearly extends substantially perpendicular to the circuit board for connection therewith. (for example, see Japanese Patent Application Publication No. 2006-4642).

An H-type electrical connector receives a mating connector parallel to the circuit board. In an H-type electrical connector, for example, there are terminals each having: a press-fit section t secured in a through hole formed in a bottom wall of a housing; a contact section that linearly extends in the housing from the press-fit section to contact a mating terminal; an extend section that linearly extends outside of the insulating housing from the press-fit section; a bend section that continues to the extend section; and a connection section that extends downward from the bend section so as to be substantially perpendicular to a circuit board to which it is connected. (for example, see Japanese Patent Application Publication No. Hei 11-26058).

Here, during assembly of the V-type electrical connector and the H-type electrical connector, the terminal is generally inserted, in the housing, from the side of a connector interface with the mating connector. The terminal is press-fitted and fixed into the housing with the connection section, which is to be connected to the circuit board, projecting from the housing.

To mount the electrical connector, the connection sections of the terminals are inserted, by machine, into respective through holes of the circuit board. Here, when the terminals are not aligned in parallel with one another, a problem arises in which the connection sections of the terminals are not inserted into the respective through holes and the electrical connector cannot be mounted.

Moreover, in the electrical connector in which the plural terminals are press-fit into the housing, the connection sections of all the terminals need to be inserted into the through holes of the circuit board at one time when the electrical connector is mounted. For this reason, the electrical connector is generally provided with a terminal aligning plate (tine plate) having plural through holes formed thereon in order to align the connection sections of the terminals to be inserted into the through holes of the circuit board at predetermined positions. In this case, when the terminals are not aligned in parallel with one another, there arises a problem in that the connection sections are not inserted into the through holes of the tine plate when it is attached.

The problems are exasperated by longer length between the press-fit section and the connection section of each terminal, because such lengthening causes greater angular displacement of the connection section.

For example, in a case where the electrical connector is attached to an upper-layer circuit board of two circuit boards arranged in parallel with each other, the length between the press-fit section and the connection section of the terminal is necessarily increased, thus causing exasperation of the alignment problem.

### SUMMARY

It is an object of the present invention, among others, to provide a contact insertion guide structure and an electrical connector in which displacement of a connection section is suppressed with contacts press-fitted.

A contact insertion guide structure has a contact and an insulative housing. The contact has a mating portion for contacting a mating contact at one end, a terminal portion for connecting to a circuit board on an opposite end, and a press-fit section between the mating portion and the terminal portion. The housing has a contact receiving passageway through which the contact is inserted, and a securing section which is formed in an inner wall of the contact receiving passageway and into which the press-fit section is received. The housing further includes a wide section that does not contact the contact and is formed in an inner wall of the contact receiving passageway proximate to the securing section. A contact support section is formed in the inner wall of the contact receiving passageway. The contact support section guides the contact while coming in contact with it at the time of insertion. The contact support section also supports a portion of the contact between the mating portion and the press-fit section.

### BRIEF DESCRIPTION OF THE DRAWINGS

The invention will be explained in greater detail in the following with reference to embodiments, referring to the appended drawings, in which:

FIG. 1 is a perspective view of a contact insertion guide structure and an electrical connector according to a first embodiment of the present invention;

FIG. 2 is a longitudinal cross-sectional view of the electrical connector shown in FIG. 1;

FIG. 3 is an enlarged exploded view of housing portion A illustrated in FIG. 2 in a state before a terminal is inserted into the housing;

FIG. 4 is a partial cross-sectional view taken along a line 4-4 of FIG. 3;

FIG. 5 is a partial cross-sectional view illustrating a state where the terminal is further inserted from a first insertion state illustrated in FIG. 4;

FIG. 6 is a partial cross-sectional view illustrating a state where the terminal is further inserted from a second insertion state illustrated in FIG. 5;

FIG. 7 is an enlarged exploded view of housing portion A illustrated in FIG. 2, according to a second embodiment in a state before a terminal is inserted into the housing;

FIG. 8 is a top view of a contact insertion guide structure and an electrical connector according the second embodiment of the present invention p; and

FIG. 9 is a longitudinal cross-sectional view of the electrical connector illustrated in FIG. 8.

### DETAILED DESCRIPTION OF THE EMBODIMENT(S)

Embodiments of the present invention will be described below with reference to the drawings.

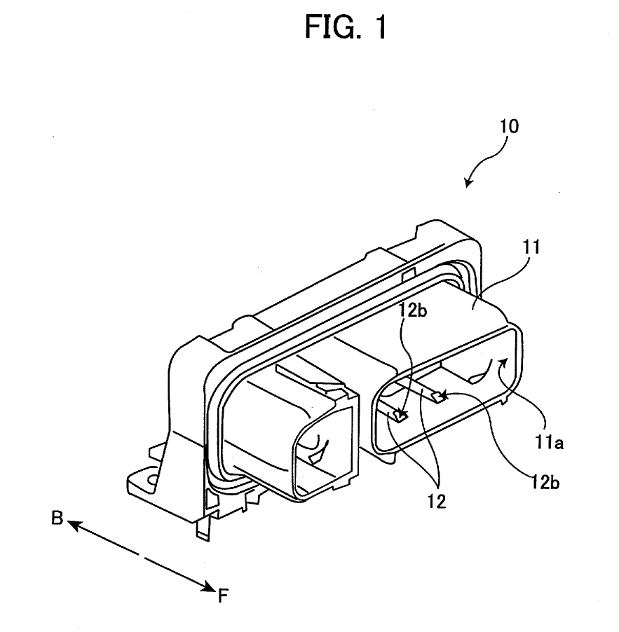

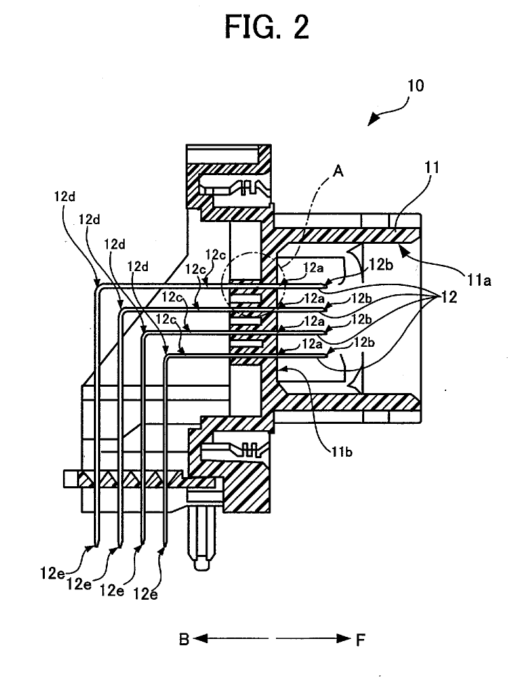

An H-type electrical connector 10, as illustrated in FIGS. 1 and 2, has an insulative housing 11 mountable on a circuit board and contacts 12 in the housing 11. It should be noted that an illustration of the circuit board is omitted for clarity.

The housing 11 has, as illustrated in FIGS. 1 to 3, connector receiving openings 11a, contact receiving passageways 11c, and securing sections 11d. Suitable insulative materials for the housing 11, include, but are not limited to, synthetic resins such as PBT, or syndiotactic polystyrene (SPS). A mating electrical connector (not shown) is received in the connector receiving opening 11a.

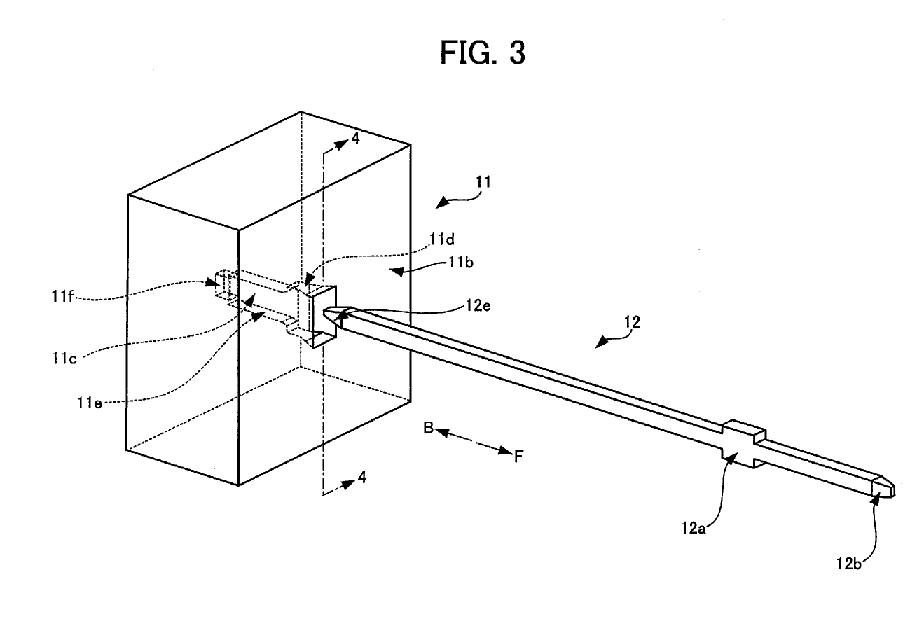

The contact receiving passageways 11c are formed in a contact securing wall 11b. The securing sections 11d are formed in an inner wall of the contact receiving passageways 11c so as to be larger than a terminal portion 12e of the contact 12. More specifically, the securing section 11d is formed to be wider in the upper and lower direction, as best shown in FIG. 3. Additionally, the securing section 11d is dimensioned to be slightly narrower than a press-fit section 12a of the contact 12.

As illustrated in FIG. 2, the contacts 12, arranged in four vertical rows, are secured to the housing 11 so as to be parallel with one another along the width of the connector 10.

The contacts 12 are stamped and formed or made from other suitable metal working processes. Each contact 12 includes a press-fit section 12a, a mating portion 12b, an intermediate section 12c, a bent section 12d and a terminal portion 12e as illustrated in FIGS. 1 to 3. The press-fit section 12a of the contact 12 has a generally rectangular shape projecting in a direction crossing an insertion direction of the contact 12, is press-fit and thereby secured into the contact receiving passageway 11c. The mating portion 12b projects from the press-fit section 12a of the contact 12 into the connector receiving opening 11a, and thus comes in contact with a mating contact (not shown).

The intermediate section 12c extends from the press-fit section 12a, outside of the connector receiving opening 11a and projects backward in the direction indicated by B in the drawings. The bent section 12d extends to the intermediate section 12c. The terminal portion 12e extends downward from the bent section 12d so as to be substantially perpendicular to the circuit board. Each of the mating and terminal portions 12b, 12e have tapered ends.

It should be noted that, the contact 12 illustrated in FIG. 3 is shown in a state before the bent section 12d illustrated in FIG. 2 is formed. It is subsequently bent by a known method after the contact 12 is press-fit from the state illustrated in FIG. 3.

The securing section 11d has wide section 11e and contact support sections 11f, as illustrated in FIG. 3. Each wide section 11e is formed, in the inner wall of the contact receiving passageway 11c, proximate the securing section 11d. The wide section 11e is formed to be wider than the terminal portion 12e of the contact 12, and does not engage the contact 12. each contact support section 11f is located proximate the wide section 11e and is formed to have substantially the same width as that of the terminal portion 12e. During contact 12 insertion, the contact support section 11f comes in contact with the contact 12 in order to guide the contact 12. Further, the contact support section 11f supports a portion between the terminal portion 12e and the press-fit section 12a of the contact 12, in a state where the press-fit section 12a of the contact 12 is press-fit to the securing sections 11d of the housing 11. The contact support section 11f may be formed to be partially concaved in order to come in contact with the contact 12 over its periphery.

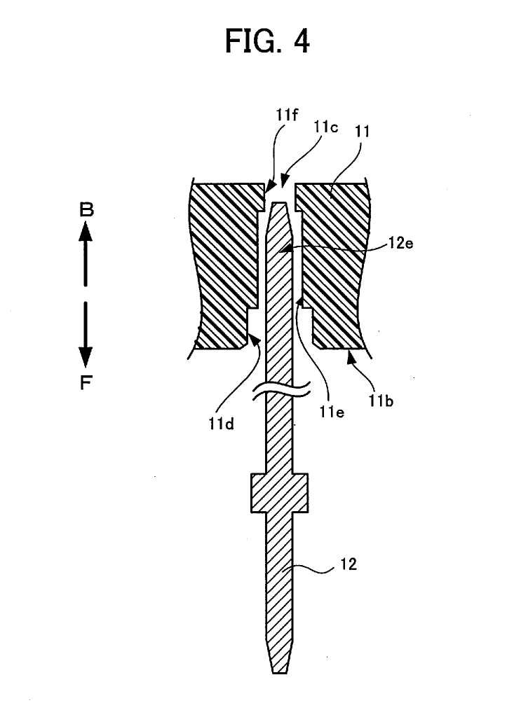

Insertion of the contact 12 into the housing 11 will now be described. FIG. 4 shows an initial step of an insertion process in which the terminal portion 12e of the contact 12 is inserted into the contact receiving passageways 11c on the forward F side. FIG. 4 illustrates a pre-insertion state.

As mentioned above, the wide section 11e and the securing sections 11d, which are formed ahead of the portion where the contact support section 11f of the contact receiving passageway 11c is formed in the forward F direction, are formed to be wider than the terminal portion 12e of the contact 12. Thus, the contact 12 does not come in contact with the inner wall of the contact receiving passageways 11c in the pre-insertion state illustrated in FIG. 4.

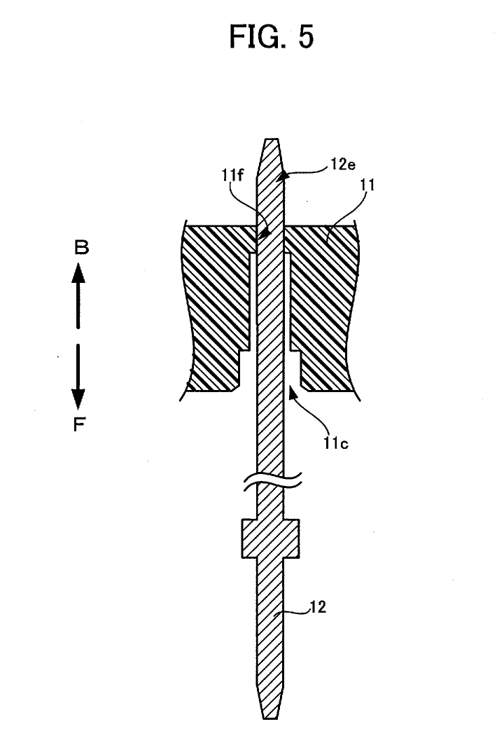

FIG. 5 is a partial cross-sectional view illustrating a state where the contact 12 is further inserted from the pre-insertion state illustrated in FIG. 4.

FIG. 5 illustrates a guide process in which the contact 12 is further inserted in the backward B direction from the pre-insertion state illustrated in FIG. 4 to be guided by the contact support section 11f of the contact receiving passageway 11c.

As mentioned above, the contact support section 11f of the contact receiving passageways 11c is formed in such a way as to have substantially the same width as that of the terminal portion 12e of the contact 12. Accordingly, in the guide state, as illustrated in FIG. 5, the contact 12 is guided while coming in contact with the contact support section 11f, whereby the contact 12 is inserted with no angle. The taper is formed on the terminal portion 12e to facilitate smooth insertion and thus prevent buckling when the terminal is inserted.

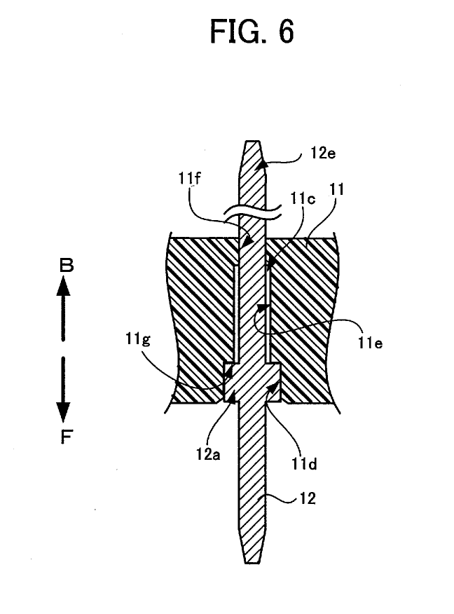

FIG. 6 is a partial cross-sectional view illustrating a state where the contact 12 is further inserted from the second insertion state illustrated in FIG. 5 and is thereby press-fit.

A third step in the insertion process is illustrated in FIG. 6, in which the contact 12 is further inserted from the second insertion state illustrated in FIG. 5 to such an extent that the contact 12 may be inserted just before the first narrow section 121 is supported by the contact support section 11f.

The securing sections 11d of the contact receiving passageways 11c are formed to be slightly narrower than the press-fit section 12a of the contact 12. When the press-fit section 12a of the contact 12 is inserted, the securing sections 11d are expanded. As a result, the contact 12 is press-fit and secured into the housing 11. The contact 12 is therefore press-fit without being angled since the contact 12 is guided while coming in contact with the contact support section 11f.

Furthermore, a step section 11g is formed at a boundary part between the wide section 11e and the securing sections 11d of the contact receiving passageways 11c. The press-fit section 12a of the contact 12, which has a convex shape, contacts the step section 11g, thereby positioning it in the insertion direction, namely, forward and backward directions F and B. The guide process is therefore reliably performed.

According to the contact insertion guide structure and the electrical connector 10 of the first embodiment, and even in the case of using the contact 12 where a portion, which extends outside of the connector receiving opening 11a of the housing 11 from the press-fit section 12a and is connected to a circuit board, is elongated, displacement of the terminal portion 12e is suppressed with the contact 12 press-fit. Hence, according to the contact insertion guide structure and the electrical connector 10 of the first embodiment, the terminal portion 12e of the contact 12 is smoothly inserted into the through hole of the circuit board when the contact 12 is mounted on the circuit board.

Moreover, in the contact insertion guide structure and the electrical connector 10 of the first embodiment, the housing 11 has the wide section 11e. This prevents the inner wall of the contact receiving passageways 11c from being shaved or cracked by the contact 12 when the contact 12 is inserted, and prevents resin waste thus shaved from being adhered to the contact 12.

Furthermore, according to the contact insertion guide structure and the electrical connector 10 of the first embodiment, the contact 12 is supported in two locations by the securing sections 11d and the contact support section 11f of the housing 11. Thus, when these two locations are molded with high precision, there is no need to precisely form the entire contact receiving passageways 11c.

A second embodiment will now be described in which the contact support section 11f, formed in the contact receiving passageways 11c of the first embodiment, is replaced with a contact support section 11h, which is different from the contact support section 11f.

Hereinafter, in the drawings, the same components as those in the first embodiment are assigned the same reference numerals as those in the first embodiment and description thereof will be omitted, and only a difference from the first embodiment will be described.

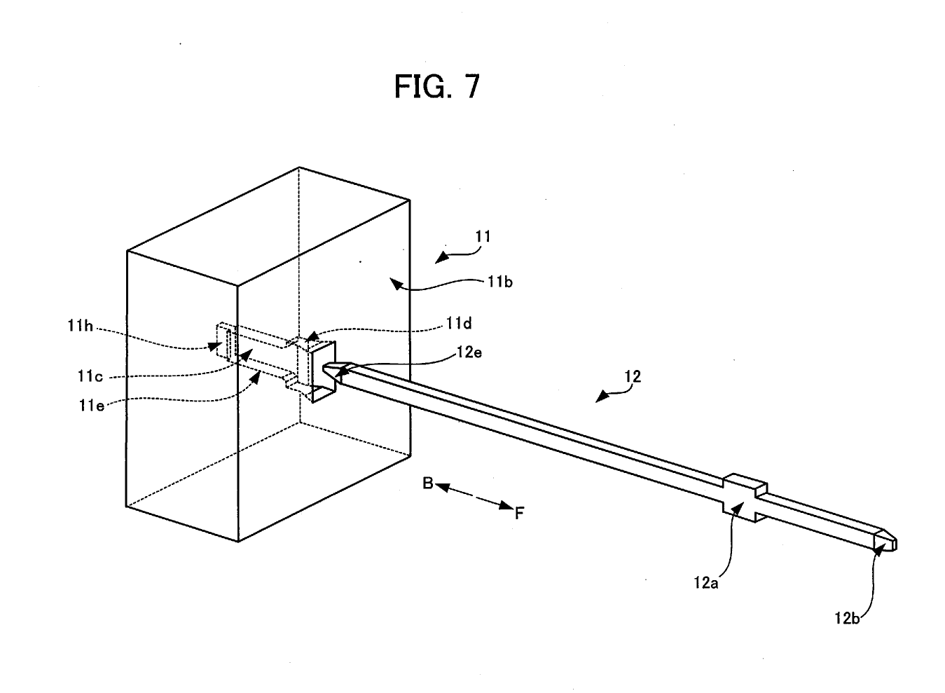

FIG. 7 is an enlarged view illustrating a state before the contact 12 is inserted into the housing 11 in the second embodiment. The housing 11 has a contact support section 11h, as illustrated in FIG. 7. The contact support section 11h is formed at a more downstream side in a direction where the contact 12 is inserted, i.e., a direction of an arrow B, than a position where the wide section 11e is formed, and is formed to have substantially the same width as that of the terminal portion 12e of the contact 12. At the time of inserting the contact 12, the contact support section 11h comes in contact with the contact 12 to guide the contact 12. The contact support section 11h further supports both side surfaces of the contact 12 in a plate thickness direction thereof between the terminal portion 12e and the press-fit section 12a of the contact 12, with the press-fit section 12a of the contact 12 press-fit into the securing sections 11d of the housing 11.

The contact 12 is a plate-like member and fluctuation in the plate thickness direction of the contact 12 is larger than that in a plate width direction thereof. However, the contact support section 11h supports the both side surfaces thereof in the plate thickness direction, thereby making it possible to suppress displacement of the intermediate section 12c with the contact 12 press-fit.

It should be noted that the first embodiment refers to an H-type electrical connector, while the third embodiment to be described below refers to a V-type electrical connector.

Hereinafter, the same components as those in the first embodiment are assigned the same reference numerals as those in the first embodiment and description thereof will be omitted, and only a difference from the first embodiment will be described.

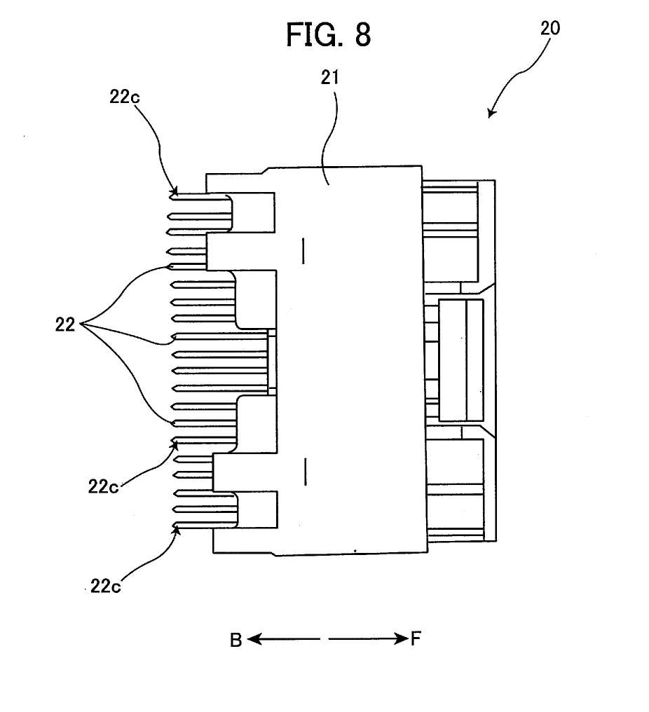

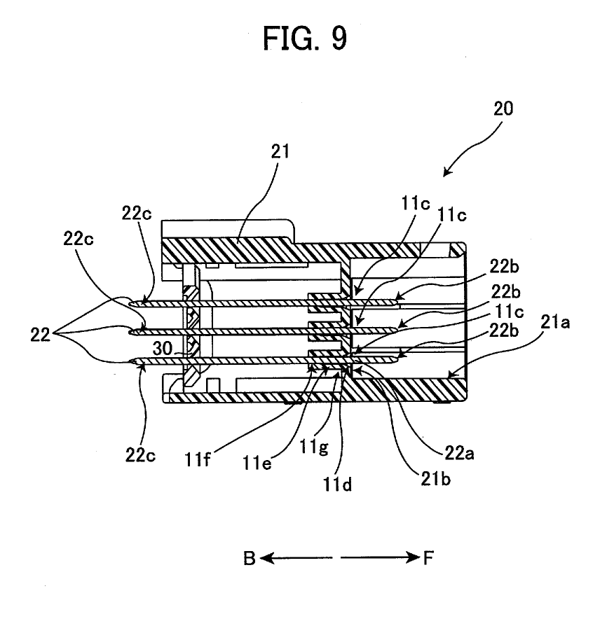

FIG. 8 is a top view of a contact insertion guide structure and an electrical connector 10 according to the third embodiment of the present invention viewed from the top, and FIG. 9 is a longitudinal cross-sectional view of the electrical connector 10 illustrated in FIG. 8.

An electrical connector 20 illustrated in FIGS. 8 and 9 is a so-called V-type electrical connector provided with an insulating housing 21 to be fixed to a circuit board and multiple contacts 22 fixed to the housing 21. It should be noted that an illustration of the circuit board to which the housing 21 is to be fixed is omitted.

The housing 21 has, as illustrated in FIGS. 8 and 9, a mating connector receiving opening 21a, contact receiving passageways 11c, and securing sections 11d. A mating electrical connector is connected into the mating connector receiving opening 21a. It should be noted that an illustration of the mating electrical connector is omitted. The contact receiving passageways 11c are formed in a contact support wall 21b of the mating connector receiving opening 21a. The securing sections 11d of the housing 21 are formed in an inner wall of the contact receiving passageways 11c. As illustrated in FIG. 9, the multiple contacts 22 arranged in three vertical rows secured to the housing 21. Moreover, the housing 21 has the wide section 11e, the contact support sections 11f, and the step sections 11g, similar to the housing 11 of the first embodiment.

The contacts 22 are plate-like members formed by stamping a metal plate, or other processes. Each contact 22 includes a press-fit section 22a, a contact section 22b, and a connection section 22c as illustrated in FIGS. 8 and 9. The press-fit section 22a of the contact 22 has a convex shape projecting in a direction crossing an insertion direction of the contact 22 (namely, forward and backward directions F and B), and is press-fit and thereby fixed into the contact receiving passageways 11c formed in the contact support wall 21b of the fitting concave section 21a of the housing 21. The contact section 22b is a part that linearly extends from the press-fit section 22a of the contact 22 toward the fitting concave section 21a of the insulating housing 21 to project in the direction of the forward F from the contact support wall 21b of the fitting concave section 21a of the housing 21 in a fitting insertion completion state where the fitting insertion is completed, and thus comes in contact with a counterpart terminal. It should be noted that an illustration of the counterpart terminal coming in contact with the contact section 22b is omitted. The connection section 22c linearly extends from the press-fit section 22a of the contact 22 outside of the fitting concave section 21a of the insulating housing 21 to project in the direction of the backward B in the fitting insertion completion state, and is thus to be connected to a circuit board substantially perpendicular to the circuit board. A taper as a guide is formed on each of the contact section 22b and the connection section 22c.

Furthermore, an alignment plate 30 is attached to the electrical connector 20 illustrated in FIGS. 8 and 9. The alignment plate 30 is a plate-like member having multiple through holes, and is used for allowing the connection sections 22c to be inserted into the through holes so that the tip ends of the connection sections 22c may be respectively aligned at predetermined positions when the connection sections 22c of the contacts 22 are connected to the circuit board.

According to the contact insertion guide structure and the electrical connector 20 of the third embodiment, which are formed as described above, is similar to the contact insertion guide structure and the electrical connector 10 of the first embodiment. Even in the case of using the contact 22 where a portion, which extends from the press-fit section 22a outside of the fitting concave section 21a of the insulating housing 21 and is connected to the circuit board, is elongated, displacement of the connection section 22c is suppressed with the contacts 22 press-fit. Thus, according to the contact insertion guide structure and the electrical connector 20 of the third embodiment, the connection section 22c of the contact 22 is smoothly inserted into the through hole of the alignment plate 30 when the alignment plate 30 is attached.

Further, according to the contact insertion guide structure and the electrical connector 20 of the third embodiment, the insulating housing 21 has the wide section 11e, similar to the contact insertion guide structure and the electrical connector 10 of the first embodiment. This prevents the inner wall of the contact receiving passageways 11c from being shaved or cracked by the contact 22 when the contact 22 is inserted, and prevents resin waste thus shaved from being adhered to the contact 22.

Furthermore, according to the contact insertion guide structure and the electrical connector 20 of the third embodiment, the contact 22 is supported by two places of the securing sections 11d and the contact support section 11f of the insulating housing 21. Thus, when these two places can be molded with high precision at the time of molding the insulating housing 21, there is no need to precisely form the entire contact receiving passageways 11c.

It should be noted that, in the embodiments described above, the description has been given as exemplifying the electrical connector. However, the contact insertion guide structure of the present invention is not limited to the electrical connector, and can be applied to various parts having a structure in which terminals are press-fit to an insulating material.

Moreover, in the embodiments described above, the descriptions have been given as exemplifying synthetic resin such as syndiotactic polystyrene (SPS), PBT or the like as a material forming the housing. However, the housing of the present invention is not limited to those, and may be formed of any material as far as it is an insulating material. Note, however, that the present invention is particularly effective in using resin such as SPS or the like having difficulty in forming through holes in accurate size and shape as compared with PBT or the like that is widely used as a material for forming a housing of the electrical connector.

What is claimed is:

1. A contact insertion guide structure, comprising:
a contact having a mating portion for contacting a mating contact at one end, a terminal portion for connecting to a circuit board on an opposite end, and a press-fit section between the mating portion and the terminal; and
an insulative housing having a contact receiving passageway through which the contact is inserted, and a securing section which is formed in an inner wall of the contact receiving passageway and into which the press-fit section is received,
wherein the insulative housing comprises:
a wide section that does not contact the contact and is formed in an inner wall of the contact receiving passageway proximate to the securing section; and
a contact support section that is formed in the inner wall of the contact receiving passageway, the contact support section guiding the contact while coming in contact with it at the time of insertion, the contact support section supporting a portion of the contact between the mating portion and the press-fit section.

2. The contact insertion guide structure according to claim 1, wherein the contact is plate-shaped.

3. The contact insertion guide structure according to claim 2, wherein the contact support section supports both side surfaces in a plate thickness direction of the contact.

4. The contact insertion guide structure according to claim 1, wherein the press-fit section has a convex shape projecting in a direction crossing the direction where the contact is inserted.

5. An electrical connector, comprising:
a contact having a mating portion for contacting a mating contact at one end, a terminal portion to be connected to a circuit board at the other end of the terminal, and a press-fit section between the mating portion and the terminal portion; and
an insulating housing having a contact receiving passageway through which the contact is inserted, and a securing section which is formed in an inner wall of the contact receiving passageway and into which the press-fit section is received,
wherein the insulative housing includes:
a wide section that does not contact the contact and is formed in an inner wall of the contact receiving passageway proximate to the securing section; and
a contact support section that is formed in the inner wall of the contact receiving passageway, the contact support section guiding the contact while coming in contact with it at the time of insertion, the contact support section supporting a portion of the contact between the mating portion and the press-fit section.

6. The electrical connector according to claim 5, wherein the contact is plate-shaped.

7. The electrical connector according to claim 6, wherein the contact support section supports both side surfaces in a plate thickness direction of the contact.

8. The electrical connector according to claim 7, wherein the press-fit section has a convex shape projecting in a direction crossing the direction where the contact is inserted.
